(19) United States
(12) Patent Application Publication
(10) Pub. No.: US 2003/0097451 A1
(43) Pub. Date: May 22, 2003

(54) Personal data repository

(75) Inventors: Margareta Gunilla Bjorksten, Cambridge, MA (US); Mitri Abou-Rizk, Newton, MA (US)

Correspondence Address: BANNER & WITCOFF, 1001 G STREET N W, SUITE 1100, WASHINGTON, DC, 20001, US

(73) Assignee: NOKIA, INC., Irving, TX

(21) Appl. No.: 09/988,002

(22) Filed: Nov. 16, 2001

(51) Int. Cl. G06F 15/16

(52) U.S. Cl. 709/228

(57) ABSTRACT

A method and apparatus are provided for controlling access to stored personal data of a user. A user indicates which portions of personal data of the user stored in a personal data repository are releasable to a second party. The user and the second party reach an agreement regarding use, by the second party, of any portions of the personal data in the personal data repository. The portions of the stored personal data in the personal data repository are released to the second party according to the agreement. The agreement includes what items within the personal data repository can be used by the second party. Only those items which, according to the agreement, can be used by the second party are released to the second party. In another embodiment of the invention, a method and apparatus are provided for selectively sending information. A trusted party device receives a request to send information. A user device is selected to receive the vendor information based on a willingness to receive the vendor information indicated within the stored personal data about the user. The vendor information is sent to the selected user device. Other aspects of the invention include a machine readable medium including instructions for a processor in a device to perform the methods described above.

### FIELD OF THE INVENTION

Aspects of the invention pertain to a personal data repository. In particular, aspects of the invention relate to a method and apparatus for a user to control access to and usage of his or her personal information in a personal data repository. Other aspects of the invention pertain to a method and apparatus for a user to control access of and usage to the user's personal information according to a contract between the user and the party requesting access to the personal information. Other aspects of the invention pertain to hiding information pertaining to the user's identity.

### BACKGROUND OF THE INVENTION

As companies realized that access to personal data is a powerful tool to improve service and product offerings, on-line collections of personal data have been increasing rapidly. The ability to better match consumers' needs and desires makes a company more efficient and reduces advertising costs while increasing customer loyalty. On the other hand, consumers are willing to provide personal information in order to receive better or less expensive services; however, because misuse of personal data is increasing, consumers' attitudes are changing.

Users currently have little or no control over profiles containing data relating to them and have limited means to express their requirements related to the use of personal information about them. For example, information about a user, including the user's email address may be sold or distributed without consulting with the user, thereby making the user more susceptible to receiving junk email. Thus, the user has no control over what information he or she receives. Further, it is often very difficult for the user to correct false information about the user in third party profiles.

Because consumers require personalized services, but are hesitant to reveal personal information, except to those parties they trust, a means of providing improved privacy of personal information is needed.

### BRIEF SUMMARY OF THE INVENTION

The above problems are solved by providing a user with control over who receives personal information pertaining to the user by providing the user with control over how profile information about the user may be collected, accessed, used and distributed by others.

A method and apparatus are provided for controlling access to, use of and distribution of stored personal data of a user. In an embodiment of the invention, a user indicates which portions of personal data of the user stored in a personal data repository are releasable to a second party. The second party may be a merchant, or one who sells a service or merchandise, or the second party may be another user, or a group of users. The user and the second party reach an agreement regarding access and use, by the second party, of any portions of the personal data in the personal data repository. The portions of the stored personal data in the personal data repository are released to the second party according to the agreement. The agreement includes what items within the personal data repository may be accessed and how the items may be used by the merchant. Only those items which, according to the agreement, can be accessed and used by the merchant are released to the merchant.

In another embodiment of the invention, a method and apparatus are provided for selectively sending vendor information. One or more trusted parties may be selected at the time of purchase of the user device or during an online registration process. The user may select the trusted party based on, for example, the trusted party's reputation, privacy policy, or reliability of the trusted party's systems, etc. In this embodiment, a user may negotiate with a second party that, in exchange for the user allowing the second party to send him information, such as vendor information, the user will be rewarded, i.e, the user will receive compensation, discounts, prizes or points toward discounts or prizes. In this embodiment, a trusted party device receives a request to send vendor information. When a user device has indicated a willingness to receive the vendor information based on a willingness to receive the vendor information indicated within the stored personal data about the user, the user device is selected to receive the vendor information. The vendor information is sent to the selected user device.

In a third embodiment of the invention, a method and apparatus are provided for controlling receipt of vendor information. A user device receives, from a second party device, a request for at least some personal data of the user. An attempt is made to reach an agreement with the second party, via the second party device, regarding use by the second party of any of the personal data of the user. Information is sent to the user device only if the agreement is reached.

In another embodiment of the invention a device, such as a second party device, may be allowed to access personal information regarding a particular interest of the user and may then build a personalized service, content or menu to be forwarded to a user's device. For example, in one embodiment, the second party device may be a music store server and the menu may contain, for example, a list of CDs by the user's favorite recording artists. In other embodiments of the invention, the second party device may be another user device, a group of user devices or a merchant device.

Other aspects of the invention include a machine readable medium having recorded thereon instructions for a processor in a device to perform methods as described above. The medium may be, but is not limited, to a Read Only Memory (ROM), Random Access Memory (RAM), a floppy disk, a hard disk or an optical disk.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an embodiment of the invention in which a user device can communicate with an application server or a trusted party device via a network, such as the Internet, or via a wireless connection;

FIG. 2 illustrates an example of the personal data repository having a master profile and one or more service profiles;

FIG. 3 is a functional block diagram illustrating an embodiment of a trusted party device;

FIGS. 4A and 4B are functional block diagrams illustrating embodiments of a user device;

FIG. 5 is a functional block diagram of another embodiment of a trusted party device;

FIG. 6 is a functional block diagram of a embodiment of a trusted party device;

FIG. 7 is a message sequence diagram illustrating an example of communications between a user device and a second party device through a trusted party device;

FIG. 8 is a message sequence diagram illustrating an example of communications between a user device and a second party device without a trusted party device;

FIG. 9 is a message sequence diagram showing an example in which a store server pushes advertising information to a user device via a trusted party device;

FIG. 10 is a message sequence diagram showing an example in which a store server device pushes advertising information directly to a user device;

FIG. 11 is a message sequencing diagram illustrating the anonymizing feature of an embodiment of the trusted party device;

FIG. 12 is a message sequencing diagram showing an example of messages exchanged in an embodiment of the invention;

FIGS. 13A and 13B are flowcharts illustrating processing within an agreement facilitator of an embodiment of a user device or a trusted party device;

FIGS. 14A and 14B are flowcharts illustrating processing within an embodiment of a rules enforcer of a user device or a trusted party device;

FIG. 15 is a flowchart illustrating processing within an embodiment of an automatic information collector of a user device or a trusted party device;

FIG. 16 is a flowchart illustrating processing within an embodiment of a data editor of a user device or a trusted party device;

FIG. 17 is a flowchart illustrating processing within an embodiment of a history recorder of a user device or a trusted party device; and

FIG. 18 is an example of an agreement between a user and a second party.

### DETAILED DESCRIPTION OF THE INVENTION

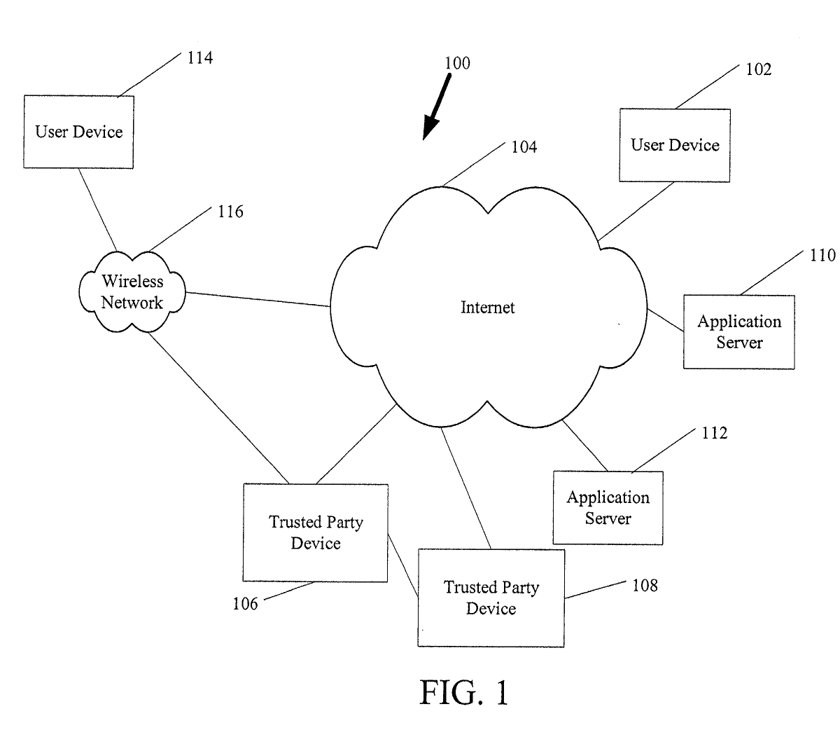

FIG. 1 shows an exemplary embodiment 100 of the invention. In this embodiment, user device 102 may communicate with a trusted party device, such as trusted party device 106 or trusted party device 108, to create, change or delete personal data about the user. User device 102 may also indicate which portions of the data may be released and to whom as well as a time period during which the data may be released. User device 102 may also communicate directly with a second party device such as application server 110, application server 112, user device 114 or a group of user devices. A user device, such as user device 114 may access a second party device via a wireless network 116. User device 114 may also access the trusted party device 106 or the trusted party device 108 via a wireless network 116.

In an embodiment of the invention, the user device may be, for example, a mobile subscriber unit, such as a wireless mobile phone, a personal computer, or a Personal Digital Assistant (PDA), all having therein a processor connected to a machine-readable medium, such as, for example, a computer memory, such as a Read Only Memory (ROM), a Random Access Memory (RAM), or a SIM card via a bus, and a means to connect with a computer network, either via, for example, a modem, DSL, cable, wireless modem, or any other well known means of connecting to a network.

The ROM may include instructions for the processor as well as static data or constants. The RAM may also include instructions for the processor, static (constants) data and dynamic (variables) data. The user device may also include other machine-readable media, such as floppy or hard disk drives and associated disks.

The application server and trusted party device may also include a processor, ROM, RAM, or other storage devices, firmware and/or software, as well as a means to connect to a computer network, as described above.

As explained in more detail below, embodiments of the invention provide a user with a way to control the dissemination of personal data of the user to second parties. The personal data is stored in a personal data repository which may include a master profile that contains the user's personal information and a service profile that pertains to a particular second party or to a type of second party. The user may create the master profile and service profile, or as explained below, the master profile and the service profile may be created automatically. The master and service profiles may reside in storage on a user's device, in a distributed manner in storage on one or more trusted party devices, or in a distributed manner in storage on one or more trusted party devices and the user device. The user can decide where the master and service profiles are to be stored and may indicate his preferences when registering for service with a trusted party.

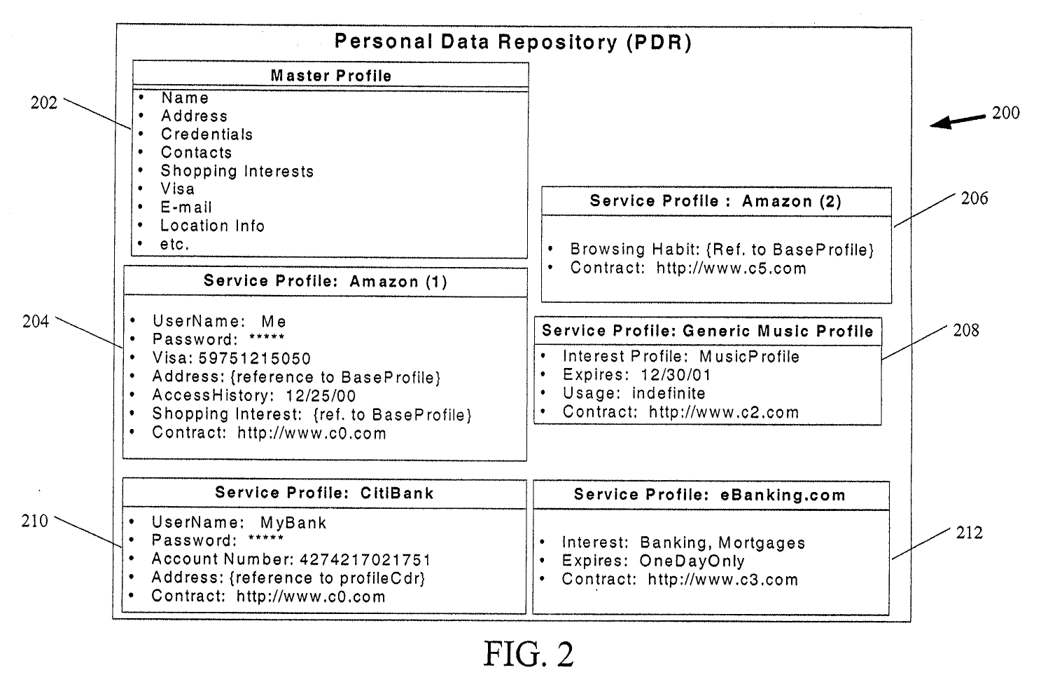

FIG. 2 shows an exemplary embodiment of a personal data repository 200. The personal data repository includes the personal data of a user. In an embodiment of the invention, the personal data of the user may be contained in a master profile 202 and in one or more service profiles. The master profile may include generic information or specific information about the user or owner of the profile depending upon the kind of information the user is willing to share. The master profile may include such items as name, address, credentials, for example, race, eye color or hair color, contacts, shopping interests, credit card information, e-mail address, location information, etc.

Service profiles include information that the user wants to share with one or more other parties. For example, a service profile may contain information that a user wants to share with only one party, such as a bank. Other service profiles, which may include a user's music interests, or may contain information that the user wants to share with several other parties, for example, a music shop or the user's friends. The user defines what can be shared, with whom, when and according to what kind of contract. Service profiles are based on this information.

An example of service profiles is shown in FIG. 2. Service profiles 204, 206, 210 and 212 contain information related to a specific service. Service profile 208 pertains to a generic music profile. Service providers may only access service profiles that pertain to them. For example, service profile 204 pertains to Amazon.com and contains information such as a username and password for logging onto the Amazon.com web site, credit card information, a reference or link to a field, such as an address in the master profile, access history showing the last time that the Amazon.com site was accessed, shopping interests, which may refer to shopping interests stored in the master profile, and a copy of a contract or a reference to a contract which describes an agreement between the user and a second party, for example, Amazon.com, the contract describing the conditions under which the second party can access, use and distribute portions of the information in the personal data repository. The service profile may also include other types of information, such as an expiration date, indicating when authorization for the second party to access, use and distribute portions of the personal data is no longer granted and an interest profile showing interests such as music or other types of interest such as banking and mortgages. The service profile may also include such information as browsing habits, for example, types of sites visited, which can be included within the service profile or a link to the browsing habits can be included in the service profile linking the service profile to browsing habits stored in the master profile. It should be noted that the service profile and the master profile may be stored completely in storage on the user device, on the trusted party device, or partly on the user device and partly on one or more connected trusted party devices in a distributed manner.

Second parties may be prevented from accessing information in profiles not intended for their use, by the use of well-known public/private encryption techniques, as well as authentication techniques, such as the use of a password. Merchants may also be verified by using digital certificates.

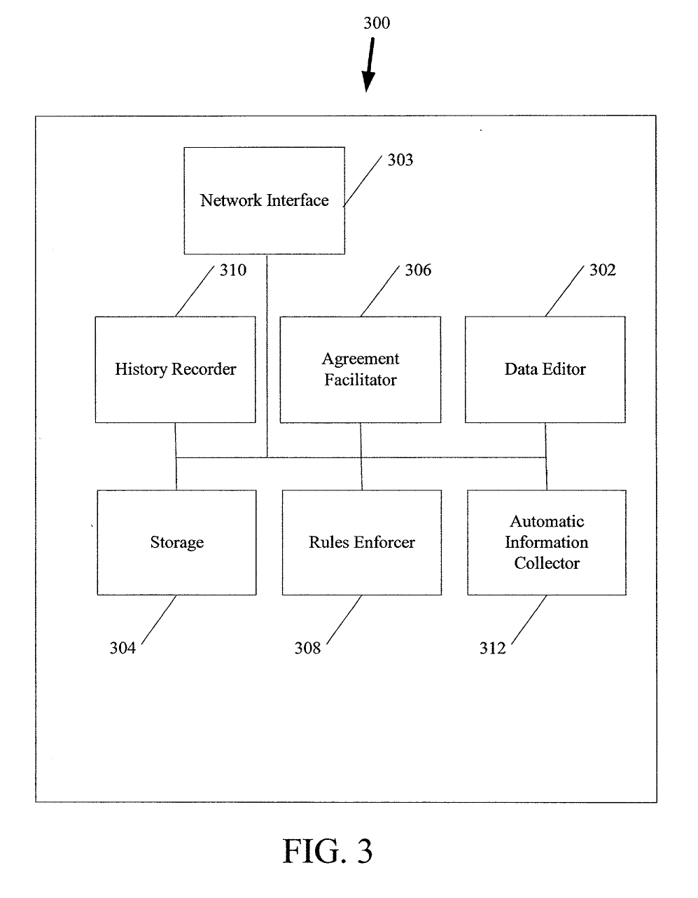

FIG. 3 is a functional block diagram of an exemplary embodiment of a trusted party device 300. The trusted party device may include a data editor 302, network interface 303, storage 304, an agreement facilitator 306, a rules enforcer 308, a history recorder 310, and an automatic information collector 312.

The data editor 302 provides an editing function and allows a user communicating with the trusted party device, via a user device, to enter a new master profile, edit the master profile, indicate which portions of the master profile may be accessed and by whom, enter the times during which the portions of the master profile may be accessed, change portions of the master profile and delete portions of the master profile. Although a service profile can be created automatically based on access and contract rules defined by the user, the user may use the data editor 302 to create a service profile, make changes to the service profile, delete portions of the service profile, indicate which portions of the service profile may be accessed by a second party associated with the profile and enter a name of the second party. The profiles may reside either on the user device or on the trusted party device. In an embodiment of the invention, when a user purchases a user device from an online store, the user may create the profiles using, for example, an online form. The user may also specify where portions of the profiles are to be stored, for example, the user device or one or more trusted devices. The information that is entered may be referenced at a later time, such that basic information need not be retyped.

The storage 304, as described previously may include, for example, RAM, a hard disk or a floppy disk, to be used to store portions of the personal data repository.

Agreement facilitator 306 is provided to aid in negotiating an agreement or contract between a user and a second party regarding the use of personal information of the user that is stored in the personal data repository. A copy of the contract or a link to the copy of the contract may be stored in a service profile.

Rules enforcer 308 enforces the rules corresponding to the agreement between the user and the second party, such that the second party can only access those portions of the personal data of the user which the user has agreed to make available to the second party for a time period, if any, agreed upon between the user and the second party.

Network interface 303 provides connectivity with a network and may be connected to a network via cable, DSL connection, modem, wireless modem, bluetooth technology or any other well known means for connecting to a network.

An embodiment of the trusted party device may include a history recorder 310 which will track the actions of the user, via the user device, and store a history of the actions in a portion of storage associated with the user's master profile. The history recorder may include a level selector, whereby a user, via the user device, may select a level of the actions to be recorded. For example, the level of recording may be set to record any activity by the user on any web site, or only purchases by the user, which the history recorder can determine by detecting when credit card information is requested, or the level of recording may be set to record only browsing activity at a particular type of web site such as online book stores.

An automatic information collector 312 may be included in an embodiment of the trusted party device to capture personal information about the user and automatically create or add to the master profile or a service profile.

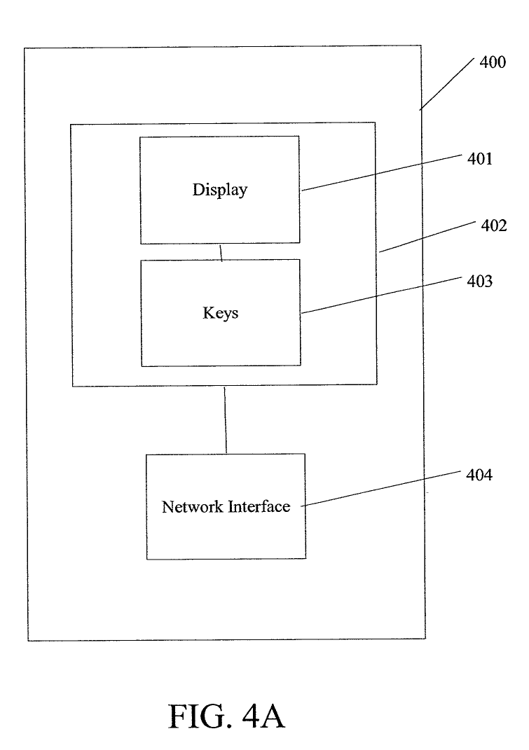

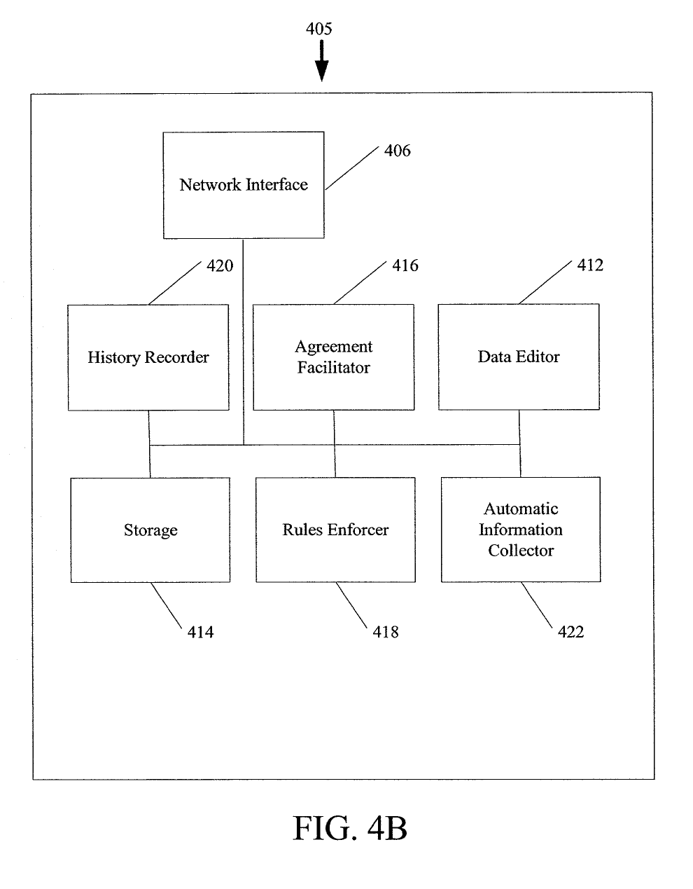

FIG. 4A is an exemplary embodiment of a user device 400 for communicating with a trusted party device wherein the trusted party device or a plurality of trusted party devices have storage for storing the user's master profile and service profiles.

Information inputter/outputter 402 may include a display 401 and an input device, such as keys 403 or a keyboard, or a speech recognition device (not shown). The information inputter/outputter 401 communicates with data editor 302 of the trusted device via a network interface 404. The network interface 404 may be connected to a network via cable, DSL connection, modem, wireless modem, bluetooth technology or any other well known means for connecting to a network. The information inputter/outputter receives input via the input device and sends the information to the data editor 302 via the network interface 404. Responses from the trusted party device are received by the user device via the network interface 404 and are displayed to the user via the display 401 of the inputter/outputter.

FIG. 4B illustrates another exemplary embodiment of a user device 405. The user device 405 may include a data editor 412, storage 414, an agreement facilitator 416, a rules enforcer 418, a history recorder 420, and an automatic information collector 422. Network interface 406 provides connectivity with a network and may be connected to a network via cable, DSL connection, modem, wireless modem, bluetooth technology or any other well known means for connecting to a network. FIG. 4B contains the same functional elements as the trusted party device shown in FIG. 3. The functional elements work as they do in the trusted party device and therefore, will not be discussed again here.

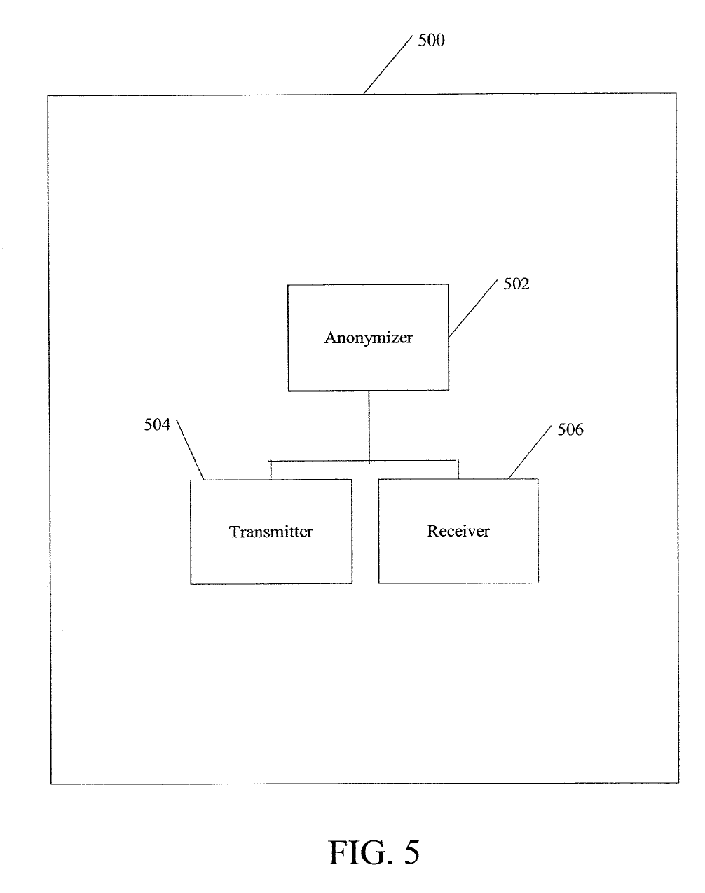

FIG. 5 illustrates an exemplary embodiment of a trusted party device with an anonymizer feature. The trusted party device 500 includes an anonymizer 502, a transmitter 504 and a receiver 506. Alternatively, the anonymizer may be included in the user device.

Anonymizer 502 strips out any information, which can be used to identify the user, from messages received from the user device before sending the messages to a second party device, thereby allowing the user to remain anonymous. For example, the anonymizer strips out information such as, IP address of the user device, routing information, and user identifying information.

Transmitter 504 transmits messages to the user device or to the second party device.

Receiver 506 receives messages from the user device or the merchant device.

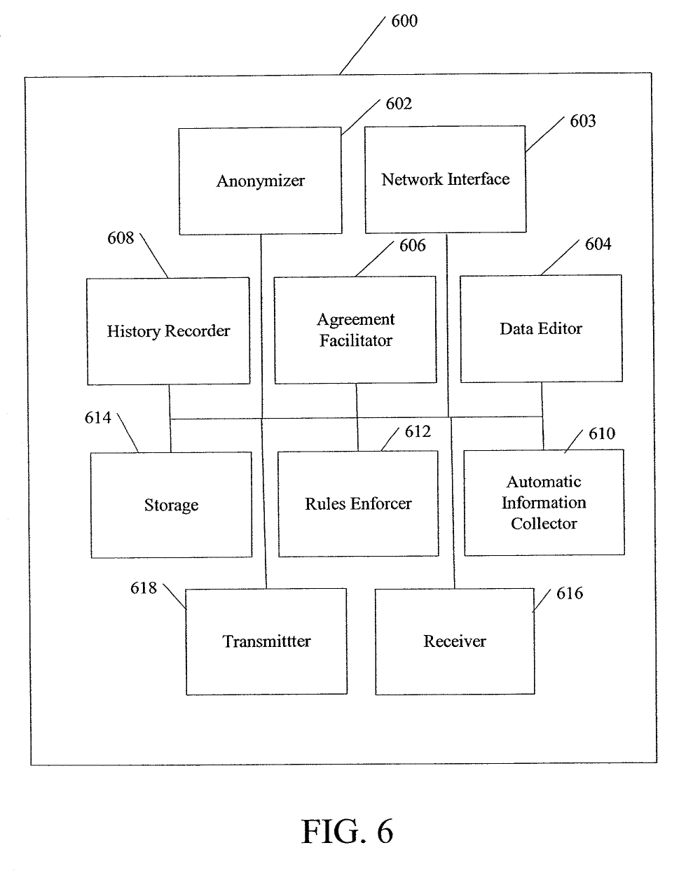

FIG. 6 shows another embodiment of the trusted party device including the anonymizer function and the functions previously described regarding the description of the trusted party device of FIG. 3. Because these functions were previously described, they will not be described again here.

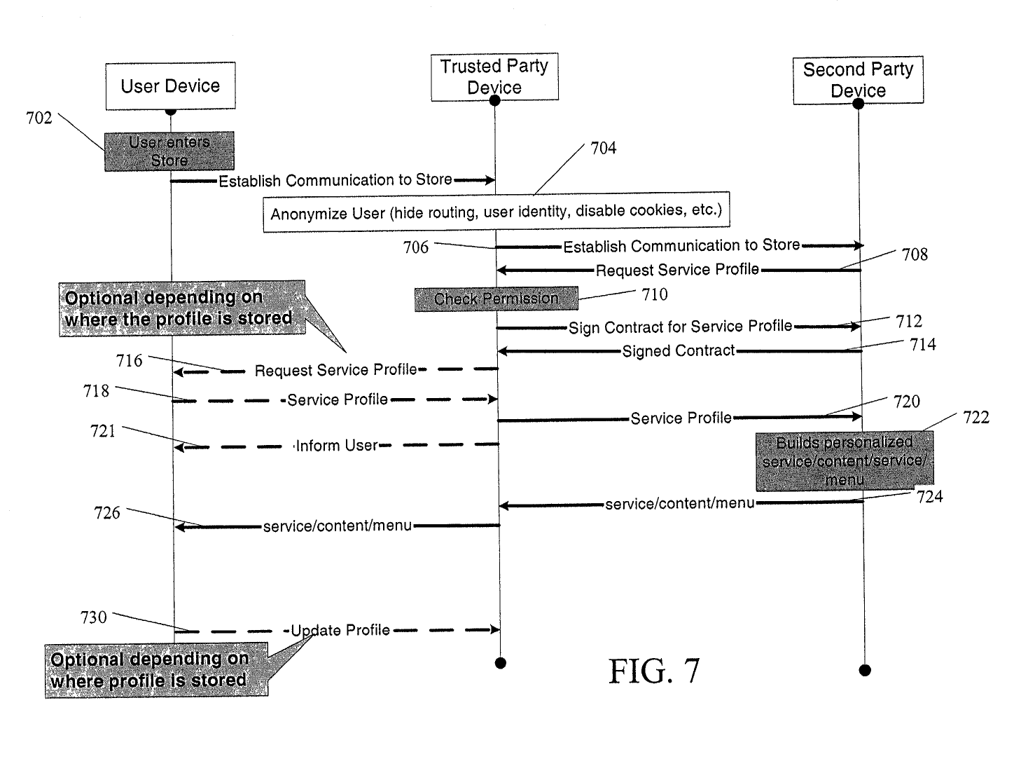

FIG. 7 helps to explain an exemplary use of an embodiment of the invention.

At 702, a user with a user device attempts to establish communication with a second party device through a trusted party device. At 704, the trusted party device anonymizes the user by performing actions such as, for example, hiding routing information, hiding user identity information and disabling cookies before sending any communications to the store.

At 706, the trusted party device forwards the message to the second party device in order to establish communication.

At 708, the second party device, having received the request to establish communication, sends a request for a service profile to the trusted party device.

At 710, the trusted party device, using the rules enforcer to examine the current rules regarding release of personal information to the particular second party, determines whether the second party associated with the second party device has permission to receive information in the service profile. If there is no pending agreement with the second party, the rules enforcer denies access to the personal information until an agreement is reached. If the second party does not yet have permission, the agreement facilitator is used to request that the second party agree to a contract with the user regarding handling of the information in the service profile. After a contract is agreed to, the second party device returns an indication of agreement to the trusted party device and stores a copy of the contract in, for example, the master profile with a reference to the contract being stored in the service profile.

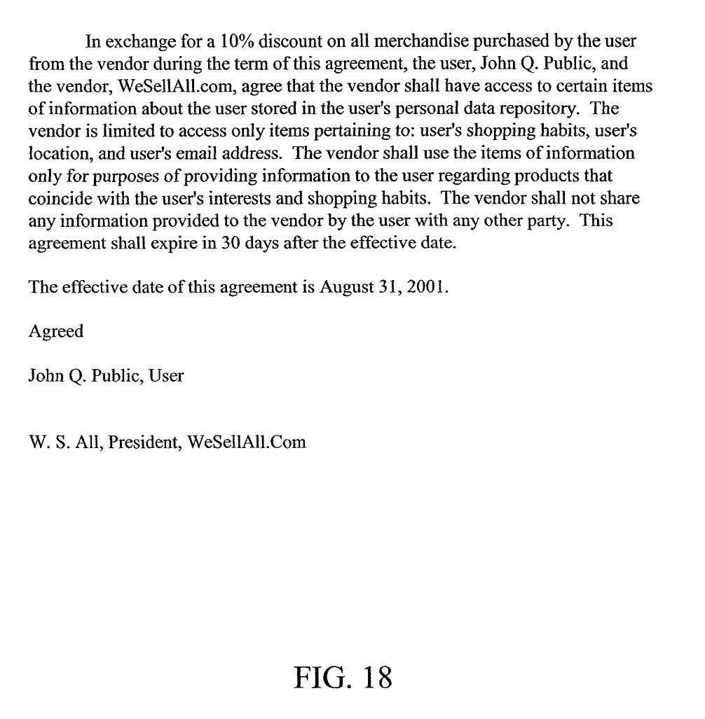

FIG. 18 provides an example of one type of agreement. The exemplary agreement is between a user and a merchant; however, an agreement could be between a user and a second party, such as a merchant, another user, or a group of users. In the exemplary agreement the user and the merchant, a vendor, agree that the user will receive a 10% discount on all merchandise purchased from the vendor during the term of the agreement, thirty days. In return, the vendor will have access to the user's personal information regarding the user's shopping habits, location, and email address. The vendor agrees to use the information provided by the user only for purposes of providing information to the user regarding products that coincide with the user's interests and shopping habits. The vendor agrees not to share the information with other parties. The term of the exemplary agreement is thirty days. Of course other types of agreements are also possible, some examples include, but are not limited to rewarding the user with points toward a discount or free gift or providing a monetary award in exchange for access to the user's personal information.

An agreement may also include whether a second party is permitted to keep a history of actions taken by the user with respect to the second party. Further the agreement may require that, if the second party shares the personal information regarding the user, that the second party inform the user regarding which parties received the shared information and any compensation the second party received for sharing the information.

At this point, the trusted party device may request and receive, at 716 and 718, the service profile, if the service profile resides on the user device. Otherwise, the trusted party device can retrieve the service profile from its own storage, or may retrieve portions from its own storage and from storage of other connected trusted party devices and return the requested service profile information, at 720 to the second party device.

Optionally, at 721, the trusted party device may inform the user that the second party device accessed the service profile.

At 722, the second party device may construct a personalized service, content or menu based on the information within the service profile. For example, if the second party is a music store, the service profile may include the user's music preferences and the personalized menu may include music selections based on the user's music preferences. At 724, the personalized service, content or menu is sent to the trusted party device, which, at 726, forwards the personalized service, content or menu to the user device.

At 730, the user's service profile may be updated. The service profile may be updated at the trusted party device or among a plurality of trusted party devices, depending on where the profile is stored. Otherwise, the service profile may be updated in storage on the user's device if the profile is stored on the user's device.

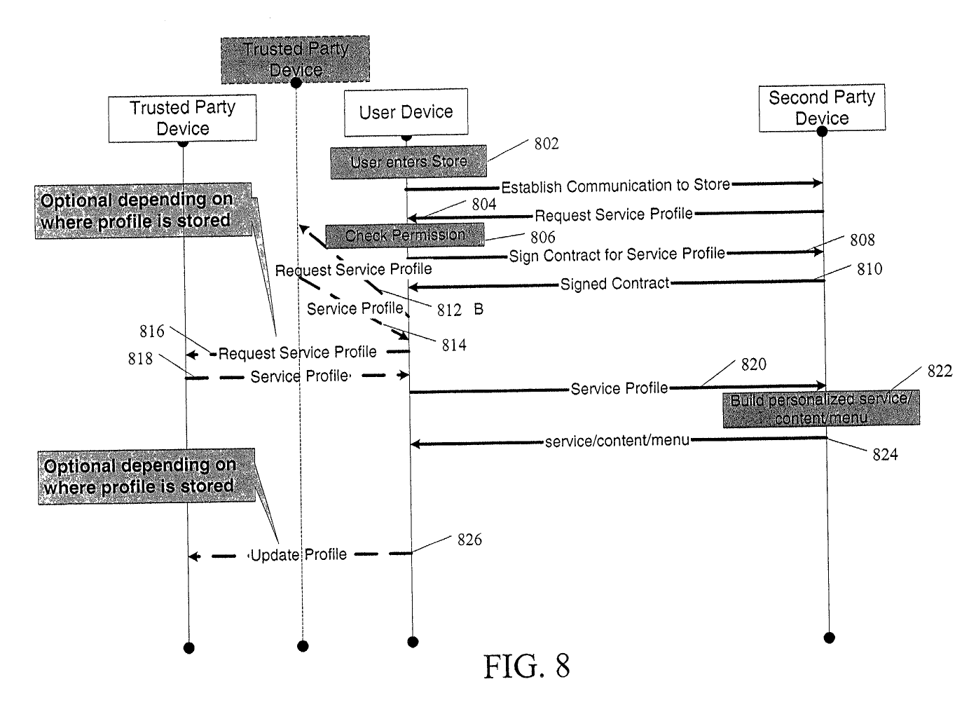

FIG. 8 demonstrates another exemplary use of an embodiment of the invention.

At 802, a user attempts to establish communication with a second party device. At 804, the second party device requests a service profile.

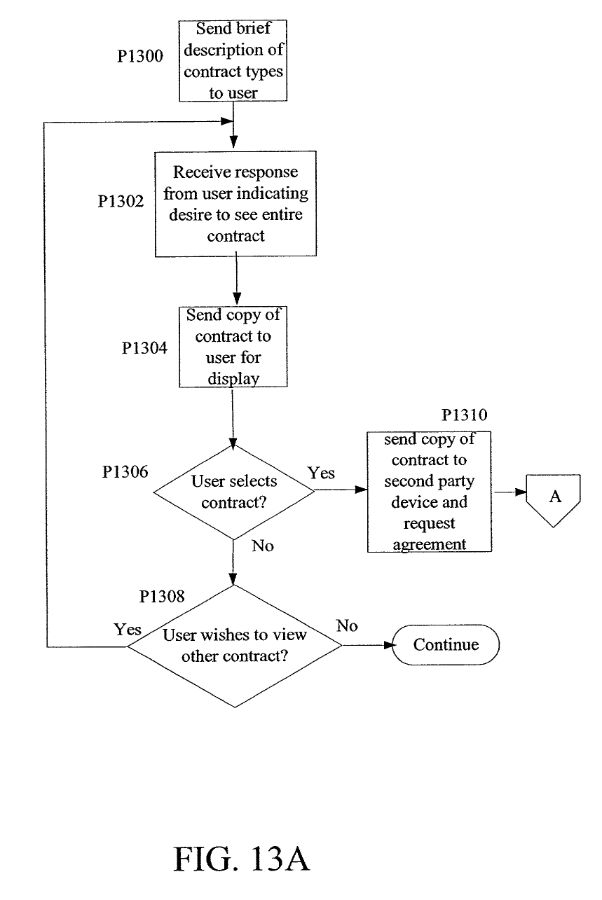

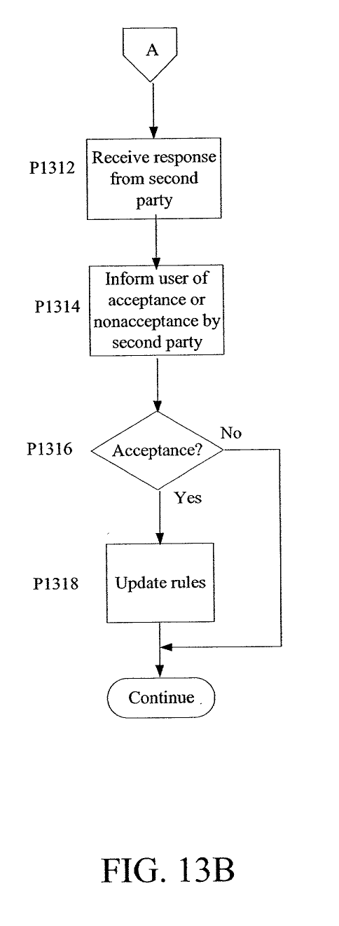

At 806, a rules enforcer determines whether the second party device has permission to receive service profile information. If the second party device does not have permission to receive the information, then the agreement facilitator within the user device requests that the second party associated with the second party device agree to a contract with the user regarding handling and use of the user's personal information within the service profile. A flowchart of the processing performed by an exemplary embodiment of the agreement facilitator is shown in FIGS. 13A and 13B and will be described later.

At 810, an agreement is reached and an indication of the agreement is sent to the user device. The agreement may be reached by the second party viewing the contract on a display and indicating approval by selecting, for example, with a pointing device, such as a mouse, a control indicating agreement. The agreement may also be reached by, for example, a second party module accepting certain standard agreements pre-approved by the vendor. The second party module may be implemented in software. After an agreement is reached, the user device may retrieve the service profile information from its own storage, from the storage of a trusted party device or may retrieve the information from more than one trusted party device, if the information is distributed among the trusted devices, as shown in 812 through 818.

At 820, the user device, having retrieved the service profile information, sends the service profile to the second party device. At 822, the second party device builds a personalized service, content or menu based on the information within the service profile, and at 824, sends the personalized service, content or menu to the user device.

At 824, the personalized service, content or menu is displayed at the user device.

At 826, the user's service profile and/or master profile may be updated. If the profiles are not stored locally on the user device's storage, then update messages are sent to one or more trusted party devices informing them to update the master and/or service profiles accordingly.

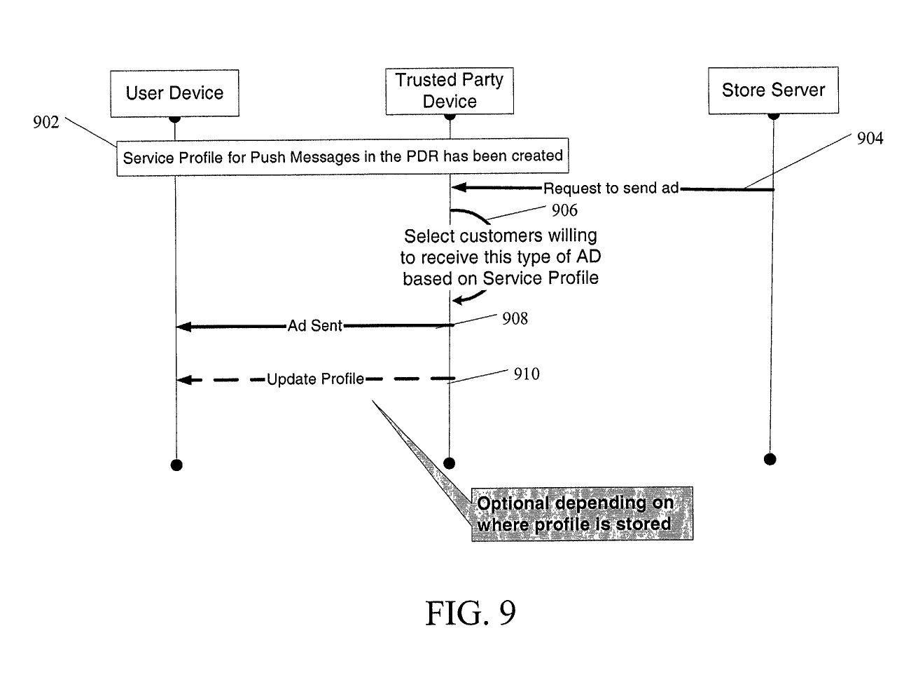

FIG. 9 provides an example of an advertisement being pushed to a user device via a trusted party device from a store server in an exemplary embodiment of the invention. Of course, the advertisement may instead be any type of information, not necessarily an advertisement, and the store server may instead be any second party device.

At 902, a user, at a user device, creates a service profile for push messages. Some time later, at 904, the store server sends a request to send an advertisement to a trusted party device.

At 906, the trusted party device or server reviews the service profile information and selects customers willing to receive this type of advertisement, based on information in the service profile, such as a flag indicating that the user will accept certain types of information.

At 908, the advertisement is then sent to users, via their associated user devices, based on the service profile information.

At 910, the master and/or the service profile information are updated. For example, the service profile may be updated to show that the merchant associated with the store server sent an advertisement to the user device. If this information is not stored locally in storage at the trusted party device, then update profile information is sent to the user device or trusted party devices responsible for storing profile information.

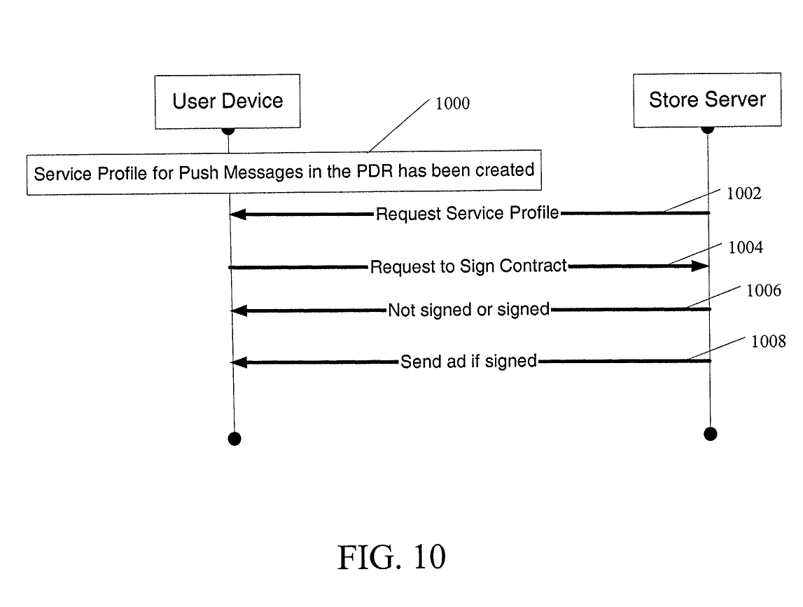

FIG. 10 shows an example of a direct push to a user device from a second party device in an exemplary embodiment of the invention. In the example shown in FIG. 10, the second party device is a store server or merchant device, but may be any type of second party device, such as a store server, another user device, or a group of user devices.

At 1000, the user device creates a service profile for push messages in the personal data repository. The profile may be created automatically via an automatic information collector in the user device or manually via a data editor in the user device.

Some time later, at 1002, the store server or merchant device requests a service profile from the user device.

At 1004, the agreement facilitator sends a request for an agreement to the store server so that an agreement can be reached between the user and the second party regarding use of the profile information.

At 1006, the store server sends an indication that agreement has been reached or has not been reached.

At 1008, if an agreement has been reached, the store server forwards an advertisement or other information to the user device.

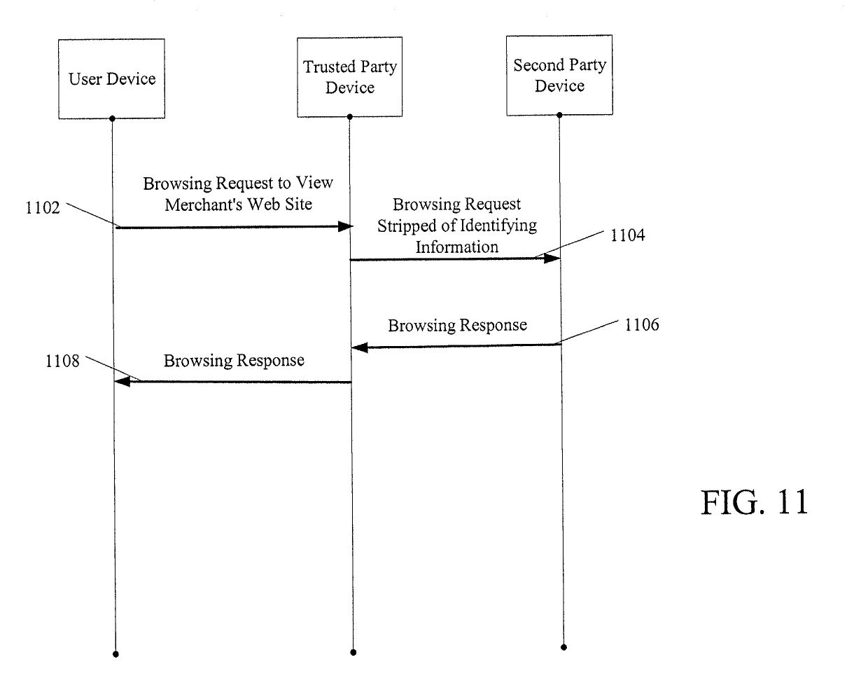

FIG. 11 illustrates the anonymizing feature in an exemplary embodiment of the invention. FIG. 11 illustrates the anonymizing feature being used with a browser; however, the anonymizing feature does not require a browser and will work with any messages being passed from a user device to a merchant device through a trusted party device.

At 1102, a user browsing on a user device sends a request to view a second party's web site. The request is received by a trusted party device, which strips out any identifying information, such as routing information (e.g., IP addresses) or anything that may identify the user and also may disable cookies. The trusted party device may replace the user's IP address with one of its assigned IP addresses in the request. A browsing request stripped of identifying information is then sent to a second party device.

At 1106, the second party device sends a browsing response to the trusted party device. The trusted party device, at 1108, maps the IP address in the message to a user device and sends the browsing response to the user device.

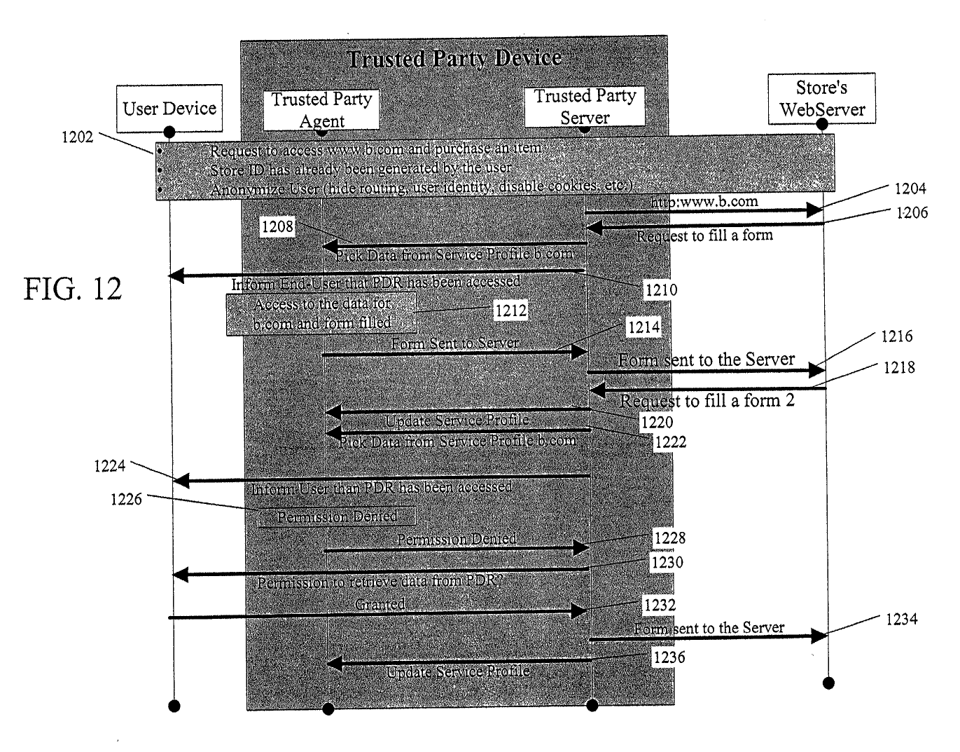

FIG. 12 shows another exemplary series of interactions that can occur between a user device, a trusted party device and a second party device, such as, for example, a store's web server.

At 1202, the user device requests access to a second party's web site, such as wwb.com in order to purchase an item. A service profile for this second party has already been created. The request to the second party's web site passes through the trusted party device, which anonymnizes messages from the user device to the second party device.

At 1204, the request for access to the second party's web site is passed from the trusted party device to the second party device.

At 1206, the second party device sends a request to complete a form to the trusted party device. The trusted party device, via its server and agent, retrieves data from the service profile in order to complete the form, at 1208.

At 1210, the trusted party device informs the user device that the personal data repository has been accessed.

At 1212, the trusted party device completes the form and at 1214 through 1216, sends the form to the second party device.

At 1218, the second party device sends a request to complete a second form to the trusted party device. There is no significance to having a request for completion of a second form. This is only an example of how an embodiment of the invention functions when completion of a second form, requiring additional user personal information, is requested.

At 1220, the trusted party device updates the service profile indicating that the profile has been accessed by the second party's device.

At 1222, the trusted party device retrieves the data needed to complete the second form.

At 1224, a message is sent to the user device by the trusted party device informing the user that the personal data repository has been accessed.

At 1226, the rules enforcer of the trusted party device determines that the requested information has not yet been authorized by the user and informs a trusted party server of the trusted party device, at 1228.

At 1230, the trusted party device sends a request to the user, via the user device, asking for permission to retrieve the data from the personal data repository. At 1232, the user grants permission to retrieve the data and sends an indication to the trusted party device. The existing contract is updated to reflect that the to be supplied data may be accessed by the second party device. At 1234, the completed form is sent from the trusted party device to the second party device.

At 1236, the service profile is updated. The updates may include, but are not limited to, for example, a password change for a second party to access the profile, a list of web pages visited, new interests, or shopping intentions.

FIG. 13 illustrates the processing performed in an exemplary embodiment of the agreement facilitator. As describer earlier, the agreement facilitator may be included within the trusted party device or within the user device.

At P1300, a brief description of contract types is sent to the user's display on the user device. The contracts may be located at a “neutral contract/agreement provider” device or at the trusted party device. The contract types may be, but are not limited to, for example, a one-time use contract (for one-time use of user information, a 30 day contract (for a 30 day use of user information), and an unlimited time period contract (for a time period with no specific ending date).

After the user indicates a desired contract type, at P1302 the user's selection is received.

At P1304, a copy of the desired contract may be retrieved from the the trusted party device or from the “neutral contract/agreement provider” device via the trusted party device and is sent to the display of the user device.

At P1306 a check is performed to determine whether the user selected a contract and if so, then at P1310, a copy of the contract is sent to the second party device. Otherwise, at P1308, a check is performed to determine whether the user wishes to view another contract. If the user does wish to view another contract, then P1302 will again be performed.

After sending a copy of the contract to the second party device, at P1310, a response is received from the second party at P1312.

At P1314, the user, via the display on the user's device, is informed of the second party's acceptance or non-acceptance of the contract.

At P1316, a determination is made as to whether the second party accepted the contract. If the contract was accepted, then the rules corresponding to the contract terms are updated.

If the accepted contract was provided by the “neutral contract/agreement provider”, then the “neutral contract/agreement provider” may receive compensation, such as a small sum, every time the contract is used.

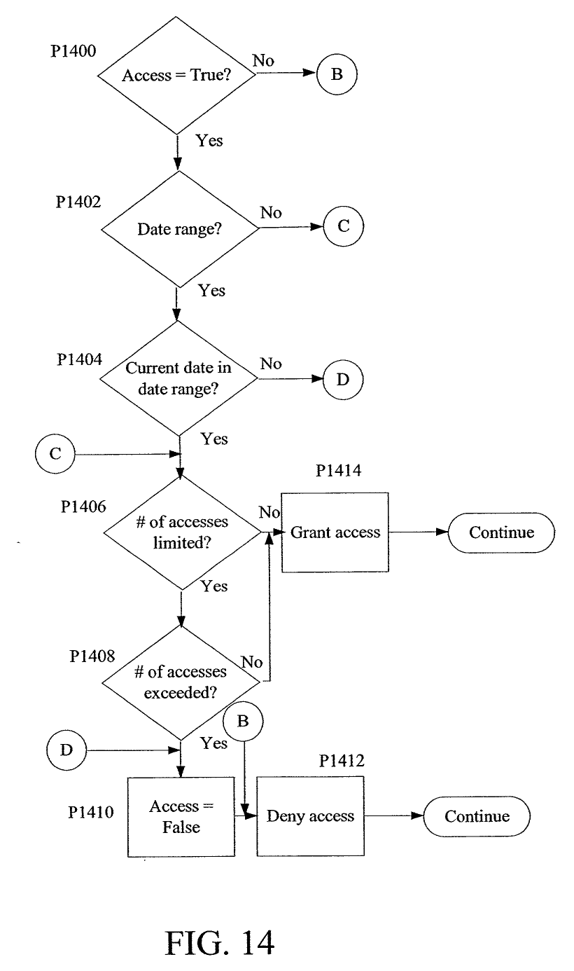

FIG. 14 is a flowchart which explains an embodiment of the rules enforcer, which may be included either within the user device or within the trusted party device.

At P1400, a check is made to determine whether the merchant was granted access to the requested information.

At P1402, a check is made to determine whether a date range applies to the granted access. If a date range does not apply, then processing proceeds to P1406. Otherwise processing proceeds to P1404.

At P1404, a check is made to determine whether the current date is within the date range. If not, processing proceeds to P1410, otherwise processing proceeds to P1406.

At P1406, a check is made to determine whether the number of accesses by the merchant is limited. If not, then access is granted at P1414, otherwise, processing proceeds to P1408.

At P1408, a check is made to determine whether the number of accesses has been exceeded. If the number of accesses has not been exceeded then P1414 is performed to grant access to the merchant device. If the number of accesses is determined to be exceeded, then at P1410, a flag is set indicating that future access should be denied and at P1412, access is denied.

If at P1408, the number of accesses is determined not to be exceeded, then P1414 is performed to grant access.

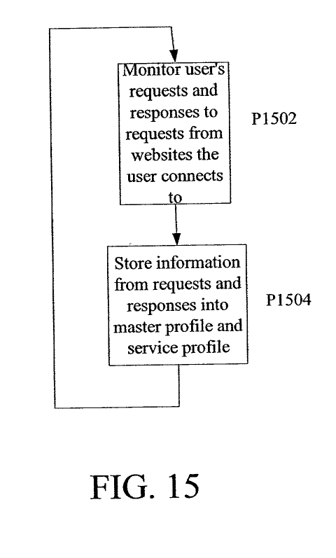

FIG. 15 is a flowchart of an embodiment of the automatic information collector which may reside on the user device or in the trusted party device. Among the types of information that the automatic information collector may store include information regarding all items a user has purchased, all the websites the user has visited, the locations that the user has most frequently visited and chat discussions with friends.

At P1502, the user's requests and responses to requests for information from websites are monitored. Such responses may include personal information, such as may reside in the master profile or service profile.

At P1504, the information from the requests and responses is stored into a master profile and may be stored in a service profile.

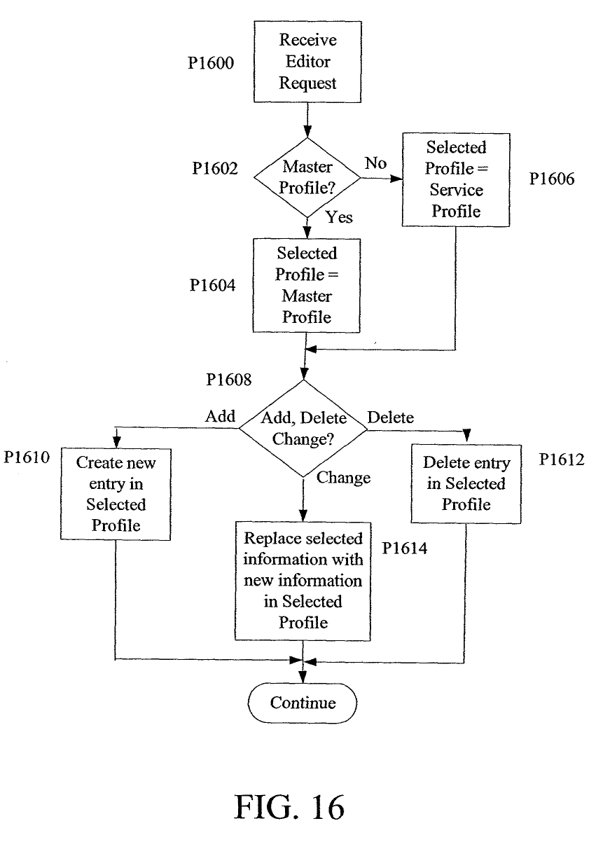

FIG. 16 is a flowchart illustrating the processing in an embodiment of the data editor which may reside in the user device or the trusted party device.

At P1600, the data editor receives an editor request for either a master profile or a service profile.

At P1602, the request is checked to determine if it is for the master profile. If the check is for the master profile, then, at P1604, the master profile will be edited. Otherwise, at P1606, the service profile will be edited.

At P1608, a determination is made as to whether a record in the selected profile will be added, deleted or changed. If information will be added, then a new entry in the selected profile is created from the information received from the user by the data editor. If the request is a deletion request, then at P1612, a selected entry in the selected profile will be deleted. If the request is a change, then at P1614 the selected information in the selected profile will be changed with new information.

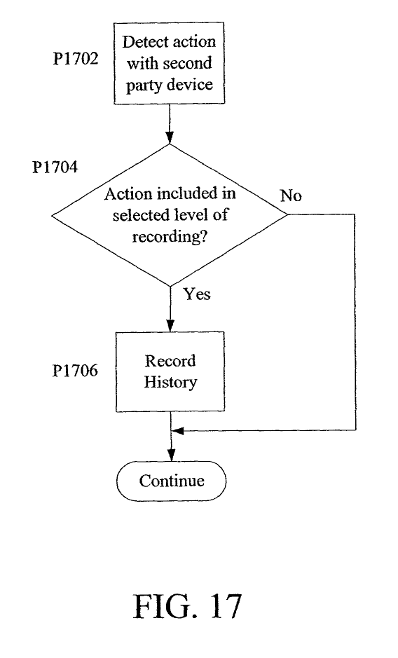

FIG. 17 illustrates the processing of an exemplary embodiment of a history recorder, which can reside either in the user device or the trusted party device.

At P1702, an action by the user is detected. The action may include sites visited by a user while browsing, purchases made by the user via the user device, or all actions occurring while browsing a particular web site or a set of web sites, such as, for example, music stores or book stores.

Optionally, at P1704, a check can be made to determine whether the user set a recording level for recording the history of actions. The level may have various settings such as, for example, recording a history of all actions, recording a history of purchases only, or recording a history of all actions occurring at one or more particular web sites. If the action is not included in the selected level of recording, then the action will not be recorded in the history. Otherwise, at P1706, the action is recorded in the history as part of the master profile or may be recorded as part of a particular service profile.

In another embodiment of the invention, a user may configure his or her user device to cause portions of the user's personal data to be stored at specific trusted party devices.

In yet another embodiment of the invention, a trusted party may act as an information broker for the user by negotiating, on the user's behalf, use of the user's personal information by the second party in return for compensation for the user. The compensation may be monetary or may include discounts for the user if the user purchases a service or merchandise from the second party.

Embodiments of the invention may include hardware, software and/or firmware.

Software or firmware embodiments may include processor instructions residing in machine-readable media, such as computer memory, for example, Random Access Memory (RAM) or Read Only Memory (ROM), as well as CD-ROM, floppy disk, or hard disk associated with the user device or one or more of the trusted party devices.

While the invention has been described with reference to certain illustrated embodiments, The words which have been used herein are words of description, rather than words of limitation. Changes may be made within the purview of the appended claims without departing from the scope and spirit of the invention and its aspects. Although the invention has been described with reference to particular structures, acts and materials, the invention is not to be limited to the particulars disclosed, but rather extends to all equivalent structures, acts and materials, such as are in the scope of the appended claims.

I/we claim:

1. A method for controlling access, use and distribution of personal data of a user stored in a personal data repository, the method comprising the steps of:
allowing a user to indicate which portions of the personal data stored in the personal data repository are releasable to a second party;
reaching an agreement, between the user and the second party, regarding use, by the second party, of any portions of the personal data in the personal data repository; and
releasing any of the portions of the stored personal data in the personal data repository to the second party according to the agreement, wherein
the agreement includes what items within the personal data repository can be used by the second party, and
only ones of the items which, according to the agreement, can be used by the second party are released to the second party.

2. The method of claim 1, wherein the personal data about the user is collected automatically.

3. The method of claim 1, wherein the step of reaching the agreement comprises choosing an agreement provided by an independent agreement provider, wherein the independent agreement provider receives compensation based on use of the provided agreement.

4. The method of claim 1, wherein the personal data about the user is entered by the user.

5. The method of claim 1, further comprising the step of storing the personal data about the user on a device operated by the user.

6. The method of claim 1, further comprising the step of storing the personal data about the user on a trusted party device.

7. The method of claim 1, further comprising the step of storing the personal data about the user in a distributed manner among a plurality of trusted party devices.

8. The method of claim 1, further comprising the step of allowing the user to perform at least one of adding, deleting or changing the personal data about the user.

9. The method of claim 1, further comprising the step of defining a service profile within the personal data repository, wherein the service profile includes portions of the personal data of the user and information regarding conditions under which items within the service profile can be used by the second party.

10. The method of claim 9, wherein the service profile includes information regarding a date and a time that any of the stored information about the user was released to the second party and to whom the stored information was released.

11. The method of claim 9; wherein the service profile includes information pertaining to a description of the agreement between the user and the second party.

12. The method of claim 1, further comprising the step of acting, by a trusted party, as an agent of the user to negotiate use, by the second party, of any of the personal data of the user in return for compensation to the user for the use of any of the personal data.

13. The method of claim 1, further comprising the steps of recording a history of actions, by the user using a user device, as part of the personal data of the user.

14. The method of claim 13, further comprising defining, by the user, of a level of a type of the actions to be recorded.

15. The method of claim 1, further comprising the steps of:
receiving, at a trusted party device connected to a computer network, a first request from a device operated by a user;
forming a second request from the first request, the second request being stripped of information that can associate the user with the second request;
sending, from the trusted party device, the second request over a computer network to a second party device;
receiving, at the trusted party device, response information in response to the sending of the second request;
forming a response based on the response information; and
sending the response to the device operated by the user.

16. A method for selectively sending information, comprising the steps of:
receiving, by a trusted party device, a request to send information;
selecting a user device to receive the information based on a willingness to receive the information indicated within the stored personal data about the user when at least one user device has indicated the willingness to receive the information; and
sending the vendor information to the selected user device when the selected user device exists.

17. A method of controlling receipt of information, comprising the steps of:
receiving, by a user device from a second party device, a request for at least some of the personal data of the user;
attempting to reach an agreement with a second party, via the second party device, regarding use by the second party of any of the personal data of the user; and
sending information to the user device only if the agreement is reached.

18. A system for providing personal data of a user with access rights being controlled by the user, the system comprising:
a user device;
a trusted party device, the user device being arranged to communicate with the trusted party device;
at least one data storage device including the personal data of the user;
a rules enforcer included in the trusted party device to enforce rules by which the personal data of the user can be accessed by a second party device, the rules having been agreed to by the user and a second party associated with the second party device, wherein:
the at least one data storage device is associated with at least one of the user device and the trusted party device.

19. The system of claim 18, further comprising a plurality of trusted party devices, each of the trusted party devices being configured to communicate with at least one other of the plurality of trusted party devices, wherein:
the at least one storage device is included in at least some of the plurality of trusted party devices and the personal data of the user is distributed among the at least one storage device of at least some of the plurality of trusted party devices.

20. The system of claim 18, wherein the trusted party device further comprises an agreement facilitator to facilitate an agreement between the user and the trusted party.

21. The system of claim 18, wherein the user device further comprises an agreement facilitator to facilitate an agreement between the user and the trusted party.

22. The system of claim 18, wherein the at least one data storage device has recorded therein a service profile within a personal data repository, wherein the service profile includes portions of the personal data of the user and information regarding conditions under which items within the service profile can be used by the second party.

23. The system of claim 18, wherein the trusted party device further comprises a history recorder to record a history of actions performed by the user device.

24. The system of claim 23, wherein the history recorder includes a level selector by which the user, via the user device, can select one of a plurality of levels of a type of the actions to be recorded.

25. A system for providing personal data of a user with access rights being controlled by the user, the system comprising
a user device;
a second party device, the user device being arranged to communicate with the second party device;
a data storage, associated with the user device, including the personal data of the user; and
a rules enforcer included in the user device to enforce rules by which portions of the personal data of the user can be accessed by the second party device, the rules having been agreed to by the user and a second party associated with the second party device, the rules including what items of the personal data are releasable to the second party and how the items of the personal data can be used by the second party.

26. The system of claim 25, further comprising a service profile stored within the data storage, the service profile including portions of the personal data of the user and information pertaining to an agreement describing how any of the stored information about the user can be used by the second party.

27. The system of claim 25, wherein the user device further comprises a history recorder to record a history of actions performed by the user device.

28. The system of claim 27, wherein the history recorder includes a level selector to select one of a plurality of levels of a type of the actions to be recorded.

29. A device for providing personal data of a user with access rights being controlled by the user, the device comprising:
a data storage device having recorded therein at least some of the personal data of the user;
an agreement facilitator to facilitate an agreement between the user and a second party; and
a rules enforcer to enforce rules by which items of the personal data of the user can be accessed by a second party device, the rules having been agreed to by the user and a second party associated with the second party device, the rules enforcer allowing access to only ones of the items, which according to the agreement, can be used by the second party.

30. The device of claim 29, wherein the data storage device has recorded therein a service profile within a personal data repository, the service profile including portions of the personal data of the user and information regarding conditions under which items of the stored personal data of the user can be released to the second party.

31. The device of claim 30, wherein the service profile is arranged to include information regarding a date and a time that any of the stored personal information of the user is released to the second party.

32. The device of claim 30, wherein the service profile is arranged to include information pertaining to a contract that describes how any of the stored personal data of the user can be used by the second party.

33. The device of claim 29 further comprising a history recorder to record a history of actions performed by the user.

34. The device of claim 33, wherein the history recorder includes a level selector by which the user can select one of a plurality of levels of a type of the actions to be recorded.

35. A mobile device for providing personal data of a user with access rights being controlled by the user, the mobile device comprising:
a rules enforcer to enforce the rules by which the personal data of the user can be accessed by a second party device, the rules having been agreed to by the user and a second party associated with the second party device;
a data storage device having recorded therein at least some of the personal data of the user;
an agreement facilitator to facilitate an agreement between the user and the second party, wherein:
the data storage device is arranged to have recorded therein a service profile including portions of the personal data of the user and information regarding conditions under which items within the service profile can be used by the second party.

36. A machine-readable medium having recorded thereon instructions for a processor in a device to perform the steps of:
receiving an indication regarding which portions of personal data of a user stored in a personal data repository are releasable to a second party;
reaching an agreement, between the user and the second party, regarding use, by the second party, of any portions of the personal data in the personal data repository; and
releasing any of the portions of the stored personal data in the personal data repository to the second party according to the agreement, wherein
the agreement includes what items within the personal data repository can be used by the second party, and
only ones of the items which, according to the agreement, can be used by the second party are released to the second party.

37. The machine-readable medium of claim 36, further comprising instructions for storing of the personal data about the user in a distributed manner, the personal data being distributed and stored among a plurality of devices arranged to communicate with one another.

38. The machine-readable medium of claim 36, further comprising instructions for allowing the user to perform at least one of adding, deleting or changing the personal data about the user.

39. The machine-readable medium of claim 36, further comprising instructions for allowing a defining of a service profile within a personal data repository, the service profile including portions of the personal data of the user and information regarding conditions under which items of the stored personal data of the user can be released to the second party.

40. The machine-readable medium of claim 39, wherein the service profile includes information pertaining to the agreement between the user and a second party.

41. The machine-readable medium of claim 36, further comprising instructions for recording a history of actions by the user as part of the personal data of the user.

42. The machine-readable medium of claim 41, further comprising instructions for defining, by the user, a level of a type of the actions to be recorded.

43. A machine-readable medium having recorded thereon instructions for a processor in a device to perform the steps of:
receiving, by a trusted party device, a request to send information;
selecting a user device to receive the information based on a willingness to receive the information indicated within stored personal data about the user when at least one user device has indicated the willingness to receive the information; and
sending the vendor information to the selected user device when the selected user device exists.

44. A machine-readable medium having recorded thereon instructions for a processor in a device to perform the steps of:
receiving, by a user device from a second party device, a request for at least some of the personal data of the user;
attempting to reach an agreement with a second party, via the second party device, regarding use by the second party of any of the personal data of the user; and
sending vendor information to the user device only if the agreement is reached.

45. A mobile device for providing personal data of a user with access rights being controlled by the user, the mobile device comprising:
a rules enforcer to enforce the rules by which the personal data of the user can be accessed by a second party device, the rules having been agreed to by the user and a second party associated with the second party device;
a data storage device having recorded therein at least some of the personal data of the user;
an agreement facilitator to facilitate an agreement between the user and the second party;
and
a history recorder to record a history of actions by the user via the user device, the history recorder including a level selector to select a level of the actions to be recorded, wherein:
the data storage device is arranged to have recorded therein at least a portion of a service profile including information regarding what portions of the stored personal data of the user can be released to the second party and conditions under which the portions of the service profile can be released to the second party.
